(19) United States
(12) Patent Application Publication
(10) Pub. No.: US 2017/0063289 A1
(43) Pub. Date: Mar. 2, 2017

(54) ROOF ITEM ATTACHMENT APPARATUS AND METHOD

(71) Applicant: SOLAR SLATE PLATE LIMITED, Redditch (GB)

(72) Inventor: Paul Christopher DAVIS, Sutton Coldfield (GB)

(73) Assignee: SOLAR SLATE PLATE LIMITED, Redditch (GB)

(21) Appl. No.: 15/248,669

(22) Filed: Aug. 26, 2016

(30) Foreign Application Priority Data
Aug. 28, 2015 (GB) 1515371.1

(51) Int. Cl. H02S 20/25; E04D 1/30; E04D 1/34; E04D 1/24

(52) U.S. Cl. CPC H02S 20/25; E04D 1/24; E04D 1/30; E04D 1/34; E04D 2001/308; E04D 2001/3444

(57) ABSTRACT

A roof item attachment system for fixing a relatively heavy item on the outer surface of a tiled roof comprising: a casing and an angled fixing bracket having at least three portions: a first end portion that has means to allow fixing to a roof structural member; a central portion; and a second end portion that has means of directly or indirectly fixing said roof item to be attached; wherein said casing is dimensioned to match and replace an existing tile; and further comprises: a first part and a second part that in use may be separated from each other or opened up to allow said central portion of said bracket to be inserted within said casing.

### FIELD OF INVENTION

The present invention is in the field of roof fixing systems; and particularly a system/apparatus and method for fixing items such as various types of solar panels to tiled roofs.

### BACKGROUND OF INVENTION

In recent years, high world energy prices have encouraged owners of residential and commercial properties to install solar photovoltaic and solar thermal roof panels. Fixing such panels to roofs, especially tiled roofs can be a problem.

At present installers of such systems typically cut tiles around fitted fixing brackets and use lead/mastic sealant to make the roof watertight. Unfortunately, over time, as such sealants deteriorate, this procedure will lead to rain water ingress to the internal roof substrate. Further, the cutting of the tiles is sometimes carried out incorrectly or inaccurately; and this may lead to the solar modules etc. being unsafely secured to the roof. Also, significant skill is required; and so suitably skilled roofing specialists should perform this technique. However, tradespeople without such specialist roofing skills are now frequently installing solar roof modules etc., and this situation is likely to result in maintenance problems with such installations.

In consequence of the above, current UK installation guidelines which state that: “All roof penetrations must be durably sealed using purpose made products capable of maintaining the seal during the movement and changes in temperature to which they will be subjected. Holes drilled through roofing felt and/or roof tiles/slates sealed with mastic or silicone sealant are not considered durable.” and “External brackets or mounting frames shall be constructed to safely bear the imposed static and wind loads and must be adequately ballasted or fixed to a structural member” are often not followed; as at the present time such “purpose made products” are generally not available; especially for use with tiled roofs.

There is also a problem with tiles breaking when installers (inadvisably) stand on fitted mounting rails, and the like, whilst installing the solar modules etc., the added weight transferred onto the roof tiles directly underneath the roof fixing bracket often breaks or cracks the tiles underneath; thus leading to water ingress if they are not replaced; with a resulting cost penalty.

Similar problems exist in securely fitting other equipment to roofs in a weatherproof manner; for example, advertising hoardings and telecommunications equipment.

Cables run from photo-voltaic solar panels and enter the roof space/loft, so a means of cable entry into the roof space is required. This is usually achieved by either cutting a section of tile and using (as described above) lead/sealant material, to allow weather-proof entry of the cables through the gap created into the roof space; or by running the cables directly under the tiles themselves, which in turn kicks up the tiles slightly. Over time, because the tile is directly on the cable, any movement of the tile relative to the cable can eventually lead to cable damage and need for replacement/repair.

### SUMMARY OF THE INVENTION

An object of the present invention is to provide a roof item attachment system and method that is faster and cheaper to install than known methods. In particular, a first aim is to provide means of supporting solar panels and the like that avoids the cutting of roof tiles and the associated disadvantages of so doing. A second aim is to provide such a system and method that avoids the need of using sealants. A third aim is to provide such a system and method that readily allows piping or electrical cables (associated with the solar panels) weatherproof entry through the roof structure without the need to drill holes etc., in the roof tiles. A fourth aim is to provide such a system and method that reduces the likelihood of tile damage if operatives inadvisably stand on equipment secured to the roof, such as mounting rails.

In a first aspect the present invention comprises a hollow roof tile replacement item for use with a roof attachment system comprising a hollow casing dimensioned to match and replace an existing tile or group of tiles; said casing comprising: a first part and a second part that in use may be separated from each other or opened up to allow a central portion of a fixing bracket to be inserted within said casing. Typically, the casing will replace just a single tile.

Preferably, the first part comprises an upper member and the second part comprises a lower member. Preferably, the upper member comprises a roof portion and sidewall portions. Preferably, the lower member comprises a base portion and a sidewall portions. Preferably, a sidewall portion of the upper member or the lower member has attachment means or hinge/pivot means located along at least part thereof to facilitate separation/attachment of the upper member from the lower member; or pivoting/opening up of these members, relative to each other.

Preferably, the roof portion has an aperture that in use allows part of a fixing bracket to pass therethrough. Preferably, a side portion of the upper member or the lower member, or an end sidewall formed from their attachment together, has at least one aperture that in use allows part of a fixing bracket to pass there through.

Preferably, a shock absorbing strip is located on the inside face of the base portion such that in use it lies under the central portion of said fixing bracket. Preferably, at least one stand up wall comprising a plurality of individual side-by-side pillars are integrally mounted upon the base portion, and separated from each other by a small (vertical) gap.

Preferably, a side portion of the upper member or the lower member, or an end sidewall formed from their attachment together, has at least one aperture located at a position such that in use it allows any water that may ingress within the casing to drain away.

Typically, the casing is configured to match and replace either a flat tile or a corrugated tile.

In another aspect, the invention comprises a roof item attachment system for fixing an item on the outer surface of a tiled roof comprising: a hollow casing and an angled fixing bracket having at least three portions: a first end portion that has means to allow fixing to a roof structural member; a central portion; and a second end portion that has means of directly or indirectly fixing said roof item to be attached; wherein said casing is dimensioned to match and replace an existing tile or group of tiles; and further comprises: a first part and a second part that in use may be separated from each other or opened up, relative to each other, to allow said central portion of the bracket to be inserted within said casing. Typically, the casing will replace just a single tile.

Preferably, the first part comprises an upper member and the second part comprises a lower member. Preferably, the upper member comprises a roof portion and side portions. Preferably, the lower member comprises a base portion and sidewall portions. Preferably, the sidewall portion of the upper member or the lower member has attachment means or hinge/pivot means located along at least part thereof to facilitate separation/attachment of the upper member from the lower member; or pivoting/opening up of these members, relative to each other.

Preferably, the roof portion has an aperture that in use allows part of a fixing bracket to pass therethrough. Preferably, a sidewall of the upper member or the lower member, or an end sidewall formed from their attachment together, has at least one aperture that in use allows part of a fixing bracket to pass there through.

Preferably, a shock absorbing strip is located on the inside face of the base portion such that in use it lies under the central portion of said fixing bracket. Preferably, at least one stand up wall comprising a plurality of individual side-by-side pillars are integrally mounted upon the base portion, and separated from each other by a small (vertical) gap.

Preferably, a sidewall of the upper member or the lower member, or the end sidewall formed from their attachment together, has at least one aperture located at a position such that in use it allows any water that may ingress within the casing to drain away.

Typically, the casing is configured to match and replace either a flat tile or a corrugated tile.

In a further aspect, the invention is a method of fixing an item to the outer surface of a tiled roof, using a roof tile attachment system as described above; comprising the following steps:
(a) removing a first selected tile (T) from said roof and a plurality of tiles (T2) located above and each side to expose a roof joist (J) and a roof lath(s) (L);
(b) replacing said removed tile (T) with said lower member of tile replacement item and fixing to lath (L) by the same/similar means as that used to retain selected tile (T);
(c) placing first end said angled bracket over roof lath (L) and fixing to joist (J) using fixing means;
(d) positioning an aperture of the upper member of tile replacement item over second end of angled fixing bracket and then lowering/pivoting said upper member towards roof (R) surface in order to locate said upper member immediately above lower member, and then connecting upper and lower members, such that the central portion (12b) of the angled bracket is housed within the hollow casing;
(e) replacing said plurality of tiles (T2); and
(f) attaching item to be supported or support member/beam (B) to the second end portion of said angled bracket using conventional attachment methods.

Preferably, during step (c) a shock-absorbing member is positioned between the underside of the central portion of the angled bracket and the base of the lower member. More preferably, the shock-absorbing strip is positioned near the end of the central portion of the angled bracket that adjoins the second portion. Most preferably, the shock-absorbing strip is positioned between the stand up walls on the base of the lower member.

In another aspect, the invention comprises a method, of fixing an item to the outer surface of a tiled roof, using any of the apparatus or systems described above.

While the second end portion of the angled bracket preferably exits through the roof aperture it may alternatively exit through the second end aperture.

### BRIEF DESCRIPTION OF DRAWINGS

The invention will be described by reference to the following diagrammatic illustrations in which:

FIGS. 1(a) to 1(d) show views for a basic embodiment of the present invention in which: FIG. 1(a) is a plan view of the roof item attachment system that includes the tile replacement item (cover) and the angled bracket; FIG. 1(b) shows a sectioned side view corresponding to FIG. 1(a); FIG. 1(c) shows an end view corresponding to FIG. 1(a); and FIG. 1(d) shows an (opposite) end view but without the angled bracket.

FIGS. 2(a) and 2(b) show a second configuration for the angled bracket;

FIG. 3 shows a perspective drawing of a preferred embodiment of the roof item attachment system with the three basic components separated—as they would be before fitting to a roof;

FIG. 4 shows a perspective view of the tile replacement cover illustrated in FIG. 3 but with the two basic components assembled—as they would be after fitting to a roof;

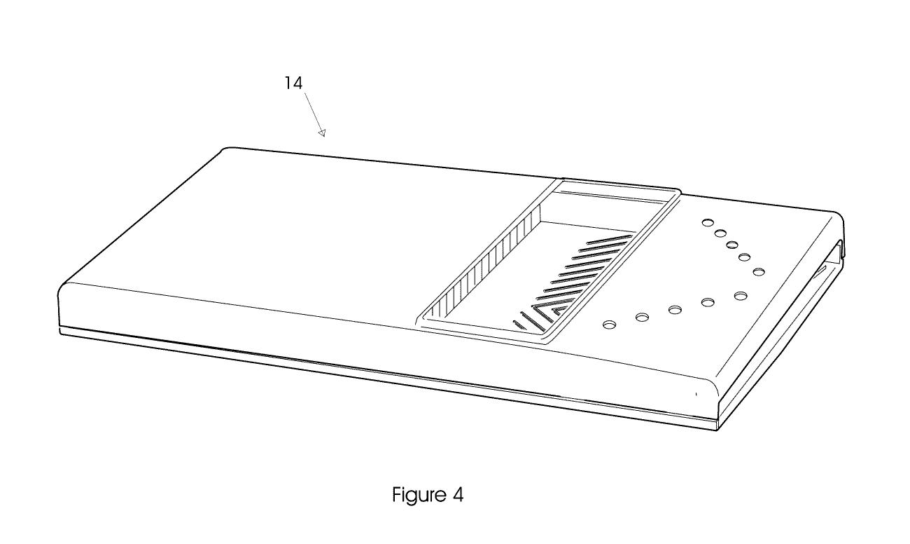

FIG. 5 shows a perspective drawing of an alternative embodiment of the tile replacement cover comprising an upper member and a lower member pivotally connected thereto, in this case by means of a side hinge;

FIG. 6 shows a plan view of a tiled roof to which a roof item attachment system according to the present invention has been fitted; and

FIG. 7 shows a sectioned side view corresponding to FIG. 6.

### DETAILED DESCRIPTION OF THE DRAWINGS

### First (Basic) Embodiment

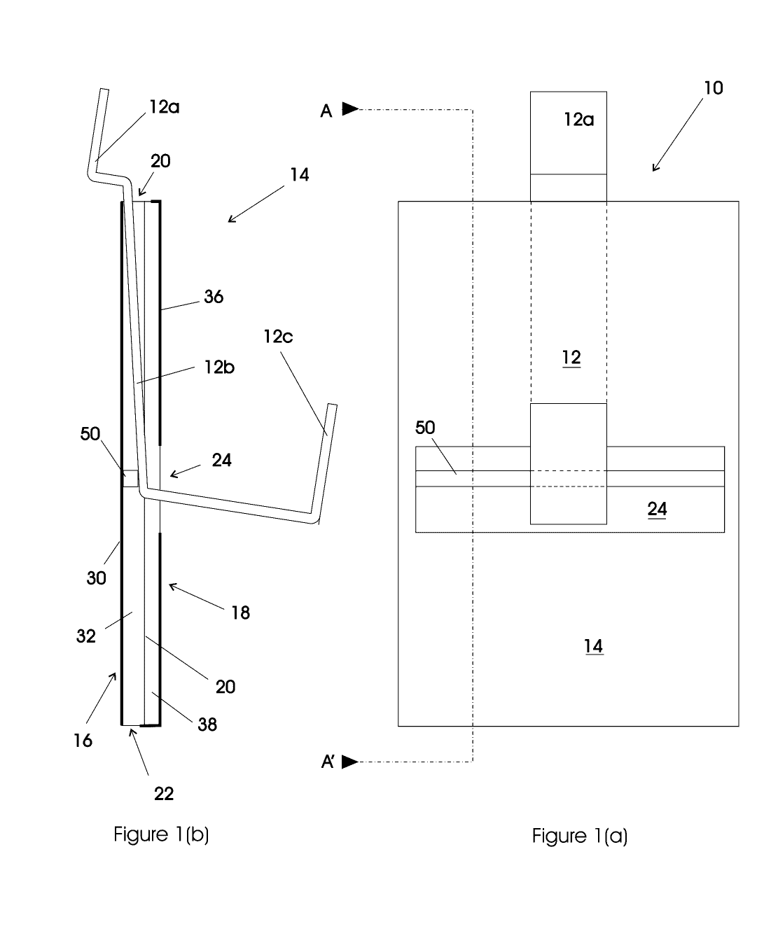

A first (basic) embodiment of the invention will now be described by reference to FIGS. 1a-1d. The roof item attachment system (10) comprises three major components, namely: an angled fixing bracket (12); and a hollow two-part tile replacement item (14), comprising a lower member (16) and an upper member (18). The replacement item (housing) is hollow so that in use the central part of the angled bracket may be housed within its interior.

FIG. 1(b) shows a sectioned side view (along the line A-A′) (see FIG. 1a) of both the angled fixing bracket (12) and the hollow tile replacement item (14); with the angled fixing bracket in a position that it would typically be in use; however in use, the angled fixing bracket (12) and the tile replacement item are independently fixed to a roof structural member; and so their relative positions may vary somewhat.

The lower member (16) comprises a rectangular and substantially flat base portion (30) with an adjoining sidewalls (32) and end walls (34) that extends around the perimeter of the base portion (30) but is of lower height at the two ends so that in combination with the upper member it provides a first end aperture (20) and a second end aperture (22) as shown in FIGS. 1(c) and 1(d) respectively.

The upper member (18) comprises a rectangular and substantially flat roof portion (36) with an adjoining sidewalls (38) and end walls (40) that again extend around the perimeter of the roof portion (36) but is of lower height at the two ends so that in combination with the lower member it provides a first end aperture (20) and a second end aperture (22) as shown in FIGS. 1(c) and 1(d) respectively.

The angled fixing bracket (12) has three portions: a first end portion (12a) that has means (fixing holes) to allow fixing to a roof structural member; a central portion (12b); and a second end portion (12c) that has means (fixing holes or slot) of directly or indirectly fixing said roof item to be attached

The upper member (18) also has a roof aperture (24), typically rectangular in shape and located in the flat roof portion (36), through which (in use) the second end portion (12c) of the angled fixing bracket protrudes/extends. Likewise (in use) the first end portion (12a) of the angled fixing bracket protrudes/extends through the first end aperture (20), as shown in FIG. 1(b).

The second end aperture (22) serves to allow any water (usually rain water) that may have entered the tile replacement item (14), normally via the roof aperture (24) to drain away down the tiles of the roof situated (in use) below the system (10).

In use the lower member (16) and the upper member (18) are connected using snap fit means (not shown) combined with upper member perimeter walls (38, 40) that snugly surround the lower member (16) perimeter walls (32, 34). As such (in use) the upper member (18) may be easily joined to (connected) or separated from the lower member (16).

An elongate strip (50) of shock absorbing material is fixed (in a direction perpendicular to the axis A-A′) by adhesive to the inner surface of the base portion (30), such that in use it lies underneath the central portion (12b) of the angled bracket (12) and preferably towards the end of that portion most distant from the first end aperture (20). In use, this greatly reduces the likelihood of a tile being cracked by an operative standing directly or indirectly upon the angled bracket during fitting of the system.

### Second (Preferred) Embodiment

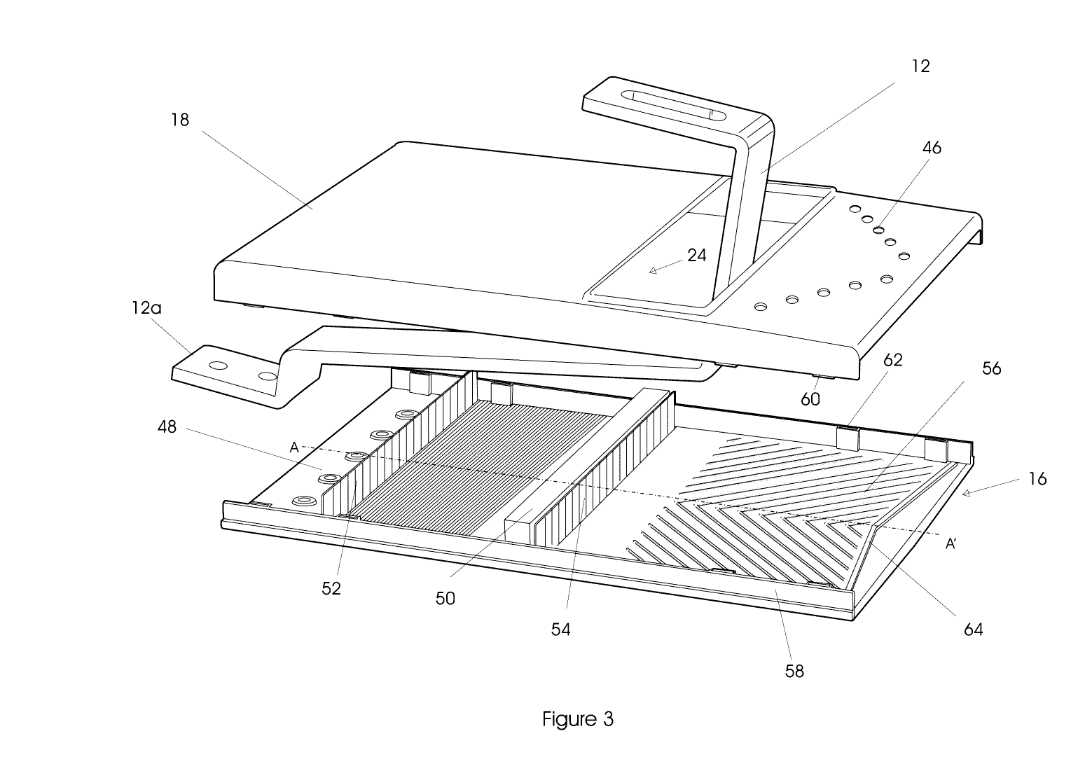

A second embodiment of the present invention will now be described by reference to FIG. 3. Components that in general correspond to those already described above (for the first embodiment) have been given the same reference numbers in FIG. 1 and will not be described again below in any detail.

FIG. 3 shows a perspective drawing of a preferred embodiment of the roof item attachment system with the three basic components (12, 16 and 18) separated—as they would be before fitting to a roof.

The lower member (16) has several features not shown in the first (above described) embodiment. Specifically, the lower member has two rows of stand up walls (52, 54) comprising around 20-30 individual side-by-side pillars integrally mounted upon the base portion (30), and separated by a small (vertical) gap. This allows one or more of these pillars to be snapped away or pushed flat to allow (in use) the, central portion (12b) of the angled bracket (12) and also any electrical cables associated with the item to pass through the hollow casing; while at the same time providing a high degree of weather proofing, in that water ingress etc. via the second end aperture (22) or the roof aperture (24) etc. is largely eliminated. Both of the stand up walls (52, 54) are located such that when the upper member (18) is in place they lie between the first end aperture (20) and the roof aperture (24).

Between the first stand up wall (52) and the first end of the lower member (16) there is provided a row of holes (48) sized to assist fixing the lower member (16) to a roof structural member (normally a roof lath) using nails or screws.

The two sidewalls (32) of the lower member each have an indent (58) extending along their entire length part way down from the upper edge and towards the flat base portion (30). In use the sidewalls (38) of the upper member snugly engage these indents (58) and together with a plurality of snap-fit elements (60, 62) ensure that in use the upper and lower members (18, 16) stay connected and in place relative to each other.

Near the second end of the lower member (16) base portion (30) a network of channels (56), angled at about 30° relative to the longitudinal axis A-A′ of the base portion (30) are provided to (in use) assist drainage of rainwater. These channels terminate at a V-shaped weir (64) located on the flat base/floor portion (30) close to the second end of the lower member. Both the channels (56) and the weir (64) are located such that when the upper member (18) is in place they lie between the second end aperture (22) and the roof aperture (24).

A plurality of drainage holes (46), located along a V-shaped pair of lines, are provided in the upper member (18) to allow drainage in the unlikely event that the primary drainage aperture (22) becomes blocked.

An elongate strip (50) of shock absorbing material is adhered near and parallel to the second stand up wall (54) (and between the first (52) and second (54) stand up walls) to the inner surface of the base portion (30), such that in use it lies underneath the central portion (12b) of the angled bracket (12) and preferably towards the end of that portion most distant from the aperture 20. In use, this greatly reduces the likelihood of a tile being cracked by an operative standing directly or indirectly upon the angled bracket during fitting of the system.

### Third (Alternative) Embodiment

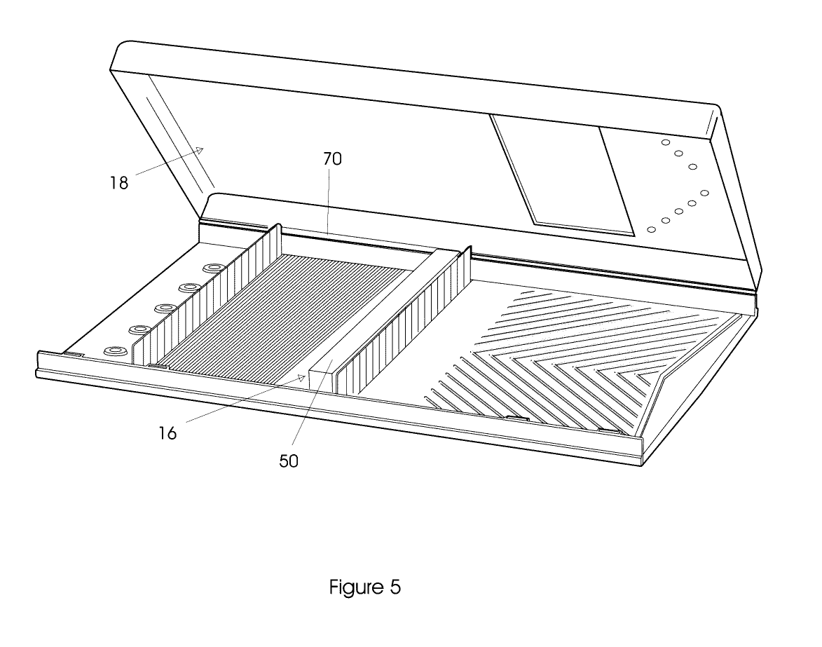

FIG. 5 shows a perspective drawing of an alternative embodiment of the roof item attachment system where the replacement cover comprises an upper member and a lower member permanently connected by an integrally formed side hinge (70). Components that in general correspond to those already described above (for the first and second embodiment) have been given the same reference numbers in FIG. 5 and will not be described again below in any detail. The upper and lower members may be none-integral the two members together facilitating hinge connection or other pivot means. Alternatively, the hinge may be located at one end of the cover, preferably the end near to weir 64.

### Common Features of all Embodiments

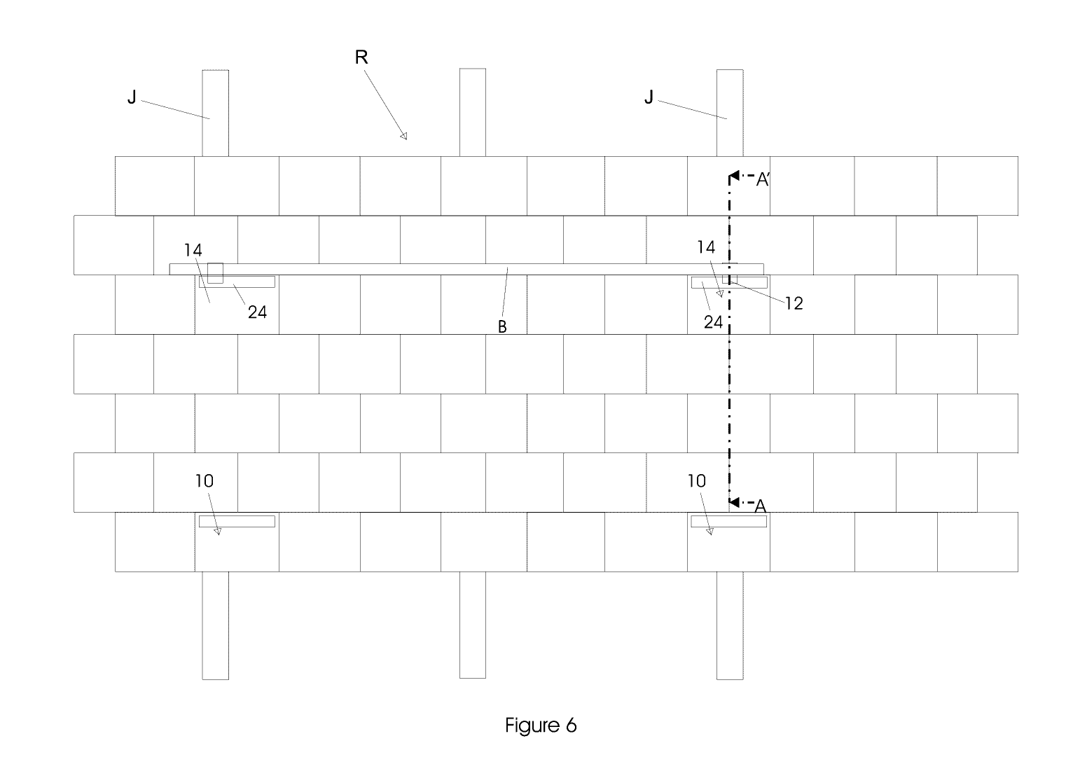

The hollow tile replacement item (14) will typically be moulded from a plastics material such as polypropylene. The first end aperture (20) and roof aperture (24) typically extends along most of the width (ca. 90-95%) of the replacement item (14) and or base member (16); thus, (in use) allowing the angled fixing bracket (12) to be located above a roof structural member—normally a roof joist (J). (as illustrated in FIG. 6).

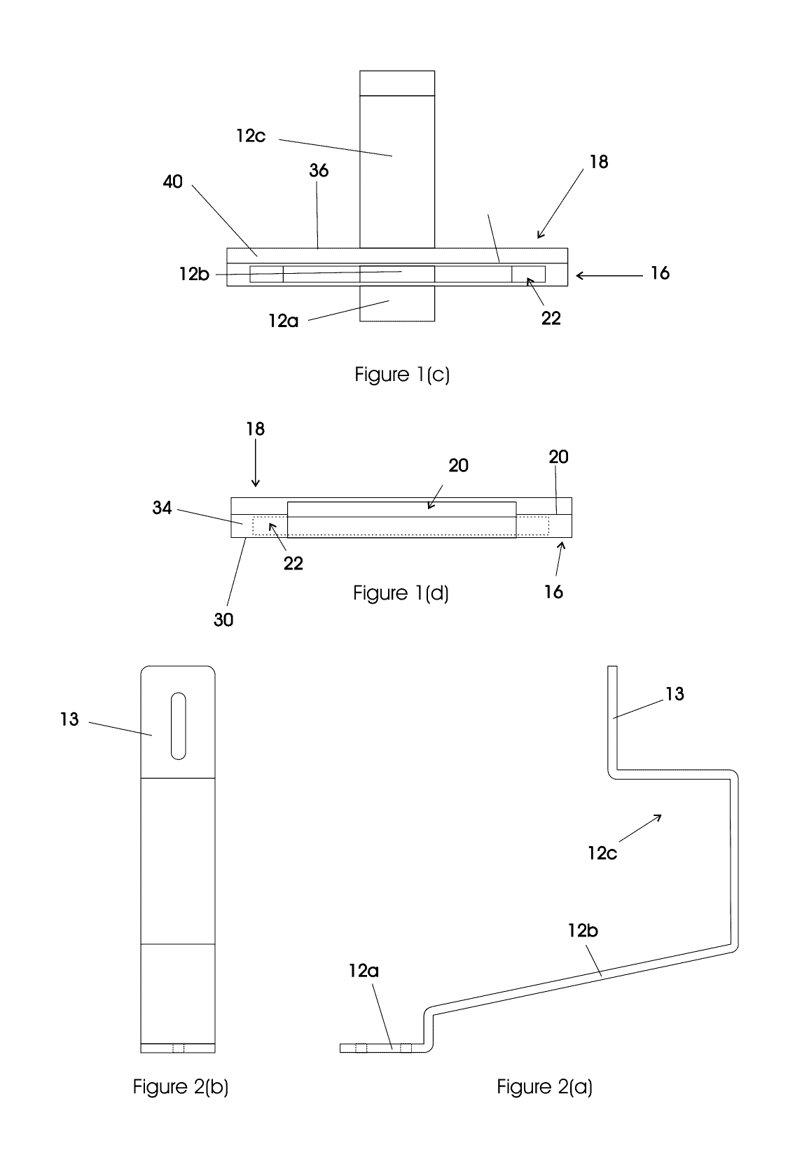

FIG. 2 shows an alternative angled support bracket configuration where the third portion (12c) comprises an additional extended portion (13) and is used when the item to be attached needs to be connected to a member that is perpendicular to the slope of the roof (R). The additional portion (13) extends in a direction that is perpendicular to the main part of the third portion (12c) and has appropriately located fixing holes/apertures.

A packer member, may in use be placed between the first portion (12a) of the angled bracket (12) and a roof joist in order to accommodate situations where the roof lath (L) is deeper than normal.

### Method of the Present Invention

The roof item attachment system of the present invention (as described above) allows support beams (B); panels etc., to be efficiently and securely fixed to a tiled roof; and also avoids subsequent water moisture ingress that might otherwise result from such work.

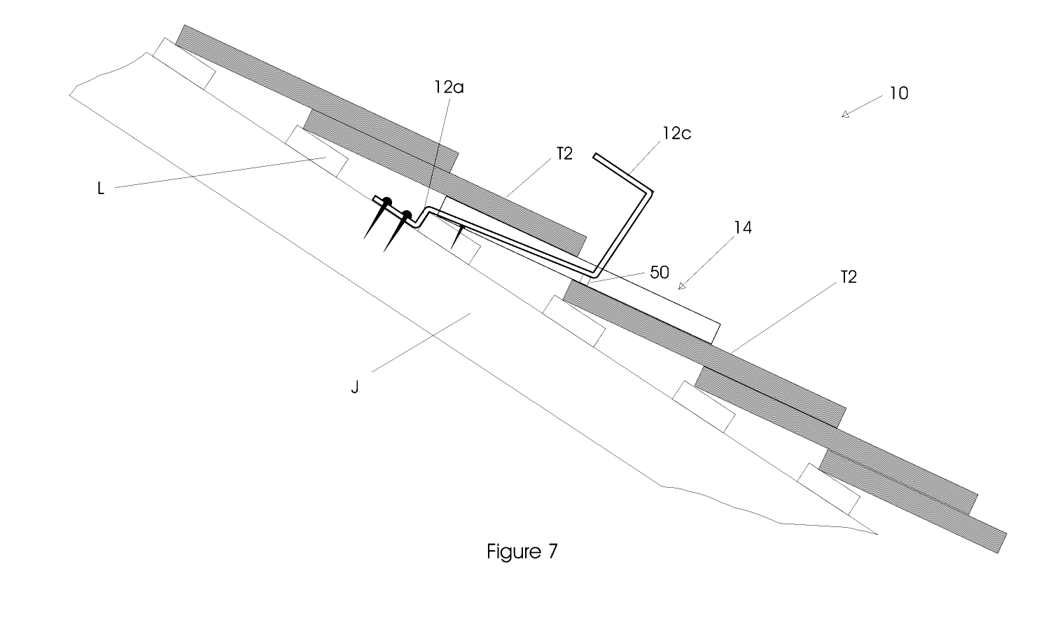

FIGS. 6 to 7 illustrate how the apparatus (10, 14) of the present invention can be used to support a solar panel (not shown) in landscape mode using a support beam (B). Alternatively, the apparatus of the present invention can be used to support a solar panel in portrait mode. If the apparatus/system of the invention (10) is being used to fix a solar panel to a roof (R) then, typically, four existing tiles/slates (T) are permanently removed from the roof and each of these tiles/slates (T) are replaced by roof attachment apparatus (10) according to the invention (see FIG. 6).

In outline, the method comprises the following basic steps:
(a) removing a first selected tile (T) from said roof and the tiles (T2) located each side and/or above to expose roof joist (J) and roof lath (L);
(b) replacing said removed tile (T) with said lower member (16) of tile replacement item (14) and fixing to lath (L) in same/similar way selected tile (T) was previously secured; typically using nails/screws that pass through holes (48) provided in lower member (16);
(c) engaging first end portion (12a) said angled bracket (12) over lath (L) and fixing to joist (J) using at least one nail/screw or the like located in fixing holes provided in first end portion (12a);
(d) positioning aperture (24, 22) of upper member (18) of tile replacement item (14) over second end portion (12c) of angled fixing bracket and then lowering or pivoting said upper member (18) towards roof surface in order to locate said upper member (18) immediately above lower member (16), and then connecting upper and lower members;
(e) replacing the tiles or tiles (T2); and
(f) attaching item (B) to second end portion (12c) of said angled bracket (12) using conventional attachment methods.

The above steps (a) to (f) are then repeated (see FIG. 6) so that end portions of item B are each supported by the second end portion (12c) of an angled bracket (12).

Normally a shock-absorbing member (50), typically shaped as an elongate rubber strip, will be located between the underside of the central portion (12b) and the inside surface of the base portion (30); and perpendicular to the longitudinal axis of the central portion (12b), as illustrated in FIG. 1(b); and typically held in place there by adhesive means. Advantageously, this member absorbs any shock loads that might otherwise result in surrounding tiles being cracked, for example situations where an operative fitting the system stands on the (fitted) beam B.

FIG. 7 illustrates a sectioned (along line A-A′) side elevation of part of the roof shown in FIG. 6 and shows how a roof item attachment system (10) according to the present invention is positioned between and under/over existing tiles (T2) supported by roof laths (L). The mounting rail (B) is secured to the bracket (12a) by conventional means (not shown)—in this example by bolts/screws/nails that pass through preformed holes in the second portion (12c) of the angled bracket (12). Normally, at least two substantial screws/nails (N) are used to secure the first end portion (12a) of the angled bracket (12) to a main structural roof joist (J) to ensure that the roof attachment apparatus (10) can bear any imposed static and wind loads. Once the tiles/slates (T2) are positioned around/over the attachment apparatus (10), as shown in FIG. 6, water can only ingress through the roof aperture (24) (and then drain away as described above). Advantageously, the first portion (12a) of the angled bracket and the means used to attach it to the roof structural members are in use covered (as is most of the central portion (12a) and made generally weather-proof by the upper member (18) of the casing (14).

While the second end portion (12c) of the angled bracket (12) preferably exits through the roof aperture (24) it may alternatively exit through the second end aperture (22).

When the first and second members (16, 18) are opened up (by pivoting or hinged movement) rather than separated, the second end portion (12c) of the angled bracket is reconfigured such that it does not impede such movement.

### Advantages of Above

The present invention advantageously eliminates the need to cut or drill tiles either to fix a mounting bracket or to thread electrical cable through (in the case where solar panels are being mounted on the roof). The invention provides a direct tile replacement with a cavity in the middle to allow access for the angled bracket to pass through so avoiding any tile kick up.

The invention advantageously avoids water leakage into the roof structure as the housing is made from a weatherproof material such as polypropylene which is ultra-violet stable and will last longer than the expected life span of the solar modules (25 years).

The invention allows much quicker installation; a typical domestic solar panel roof mounting installation requiring 4 man-hours as opposed to 2 man-days using typical prior-art methods. Thus, installation time is typically reduced by 75%.

The invention advantageously allows cable entry or exit through either the roof aperture (24) or one of the end apertures (20, 22).

The angled bracket (12) is accessible for adjustments, as the upper member (18) can easily be removed or pivoted (by hinge) open so the angled bracket position can if necessary be adjusted.

The invention provides increased protection against accidental breakage of a tile resulting from an operative inadvisably standing etc. on a part of the mount, for example a support beam (B).

The invention provides apparatus and systems that can be installed by operatives who are not skilled roofing specialists.

Advantageously, for every apparatus/system (10) that is installed a spare tile will result, so in the event that a tile does get accidentally broken, there are matching tiles from the same roof that can be used as spares, so there is no need to buy replacements.

1-26. (canceled)

27. A roof item attachment system for fixing an item on the outer surface of a tiled roof comprising: a hollow casing and an angled fixing bracket having at least three portions: a first end portion that has means to allow fixing to a roof structural member; a central portion; and a second end portion that has means of directly or indirectly fixing said roof item to be attached; wherein said casing is dimensioned to match and replace an existing tile or group of tiles; wherein said casing further comprises: an upper member and a lower member that in use may be separated from each other or opened up, relative to each other, to allow said central portion of said bracket to be inserted within said casing.

28. A roof item attachment system according to claim 27 where said upper member comprises a roof portion and a side portion and/or where said lower member comprises a base portion and a side portion.

29. A roof item attachment system according to claim 27 where a sidewall portion of said upper member or said lower member has attachment means or hinge/pivot means located along at least part of thereof to facilitate separation of said upper member from said lower member; or attachment or pivoting/opening-up of said upper and lower members, relative to each other.

30. A roof item attachment system according to claim 28 where said roof portion has an aperture that in use allows said central part of a fixing bracket to pass therethrough.

31. A roof item attachment system according to claim 27 where a side/end wall portion of said upper member or said lower member, or the side/end wall formed from their attachment together, has at least one aperture that in use allows said central part of a fixing bracket to pass therethrough.

32. A roof item attachment system according to claim 28 wherein a shock absorbing strip is located on the inside face of said base portion such that in use it lies under the central portion of said fixing bracket.

33. A roof item attachment system according to claim 28 having at least one stand up wall comprising a plurality of individual side-by-side pillars integrally mounted upon said base portion, and separated from each other by a small vertical gap.

34. A roof item attachment system according to claim 27 where a sidewall portion of said upper member or said lower member, or the sidewall formed from their attachment together, has at least one aperture located at a position such that in use it allows any water that may ingress within the casing to drain away.

35. A roof item attachment system according to claim 27 where said casing is configured to match either a flat tile or a corrugated tile.

36. A method, for fixing an item or support member to the outer surface of a tiled roof, using a roof tile attachment system according to claim 27 comprising the following steps:
(a) removing a first selected tile from said roof and a plurality of tiles located above and each side to expose a roof joist and a roof lath;
(b) replacing said removed tile with said lower member of said housing and fixing to a lath by the same/similar means as that used to retain selected tile;
(c) placing first end of said angled bracket over roof lath and fixing to joist using fixing means;
(d) positioning said roof aperture or said second end aperture of said upper member of housing over second end of angled fixing bracket and then lowering said upper member (18) towards roof surface in order to locate said upper member immediately above said lower member, and then connecting said upper and lower members so as to enclose said central portion of angled bracket within said housing, such that the central portion of said angled bracket is housed within the casing;
(e) replacing said plurality of tiles; and
(f) attaching item or support member to second end portion of said angled bracket using conventional attachment methods.

37. A method according to claim 36 further comprising: during step (c) positioning a shock-absorbing member between the underside of said central portion of the angled bracket and said base of the lower member.

38. A method according to claim 37 wherein said shock-absorbing strip is positioned: with its longitudinal axis perpendicular to the longitudinal axis of said central portion; and near the end of the central portion that adjoins the second portion.

39. Roof item attachment apparatus, to facilitate attachment of an item onto the outer surface of a tiled a roof, comprising: a hollow tile casing dimensioned to match and replace an existing tile or group of tiles; said tile casing further comprising an upper part and a lower part, that in use may be separated from each other or opened up to allow a central portion of a fixing bracket to be inserted within said casing.

40. Apparatus according to claim 39 where a roof portion of said upper part has an aperture that in use allows part of a fixing bracket to pass therethrough.

41. Apparatus according to claim 39 where said upper part comprises a roof portion and a sidewall portion and/or said lower part comprises a base portion and a sidewall portion.

42. Apparatus according to claim 39 where said sidewall portion of said upper part or said part has attachment means or hinge/pivot means located along at least part thereof to facilitate separation of said upper part from said lower part; or attachment or pivoting/opening up of these parts, relative to each other.

43. Apparatus according to claim 39 where a side/end wall portion of said upper part or said lower part, or the side/end wall formed from their attachment together, has at least one aperture that in use allows part of a fixing bracket to pass there through.

44. Apparatus according to claim 40 wherein a shock absorbing strip is located on an inside face of said base portion such that in use it lies under the central portion of said fixing bracket.

45. Apparatus according to claim 40 having at least one stand up wall comprising a plurality of individual side-by-side pillars integrally mounted upon said base portion, and separated from each other by a small vertical gap.

46. Apparatus according to claim 39 where a side portion of said upper part or said lower part, or the end sidewall formed from their attachment together, has at least one aperture located at a position such that in use it allows any water that may ingress within the casing to drain away.
